(19) United States
(12) Patent Application Publication
(10) Pub. No.: US 2016/0134770 A1
(43) Pub. Date: May 12, 2016

(54) EXTERIOR MEMBER MOUNTING STRUCTURE AND IMAGE FORMING APPARATUS

(71) Applicant: KYOCERA Document Solutions Inc., Osaka (JP)

(72) Inventors: Masaki Sato, Osaka (JP); Hiroyuki Maeda, Osaka (JP)

(21) Appl. No.: 14/932,828

(22) Filed: Nov. 4, 2015

(30) Foreign Application Priority Data
Nov. 6, 2014 (JP) 2014-225723

(51) Int. Cl. H04N 1/00

(52) U.S. Cl. CPC H04N 1/00559; H04N 1/00546; H04N 2201/0082; H04N 2201/0093; H04N 2201/0094

(57) ABSTRACT

A first locking portion restricts displacement of a portion of a first exterior member that is proximate to a second edge portion in a direction away from a body portion. An elastic member supports the first exterior member at a position proximate to the second edge portion. The elastic member retains the first exterior member at a first position where the first edge portion is overlapped with the inner side of the adjacent second exterior member, and is elastically deformed until the first exterior member is displaced from the first position to a second position where the first edge portion is not overlapped with the second exterior member.

### INCORPORATION BY REFERENCE

This application is based upon and claims the benefit of priority from the corresponding Japanese Patent Application No. 2014-225723 filed on Nov. 6, 2014, the entire contents of which are incorporated herein by reference.

### BACKGROUND

The present disclosure relates to an exterior member mounting structure and an image forming apparatus including the same.

In general, an image forming apparatus includes an exterior member mounted to a metal frame or the like that forms a part of a body portion. The exterior member is, for example, a synthetic resin cover member covering some of openings of the body portion. The exterior member may be removed from the body portion, for example, at the time of maintenance of the apparatus.

For example, the exterior member mounting structure includes lower hooks configured to support a lower edge portion of the exterior member in the body portion and fixing portions configured to fix, to the body portion, portions of the exterior member that are proximate to the upper edge portion with engaging mechanisms, screw fittings, or the like. In this case, the exterior member can be removed by a simple operation of releasing the fixation of a small number of the fixing portions and causing the exterior member to pivot outward with the hook portions as the fulcrums.

### SUMMARY

An exterior member mounting structure according to an aspect of the present disclosure includes an exterior member, a locking portion, and an elastic member. The exterior member is a member configured to be mounted to a body portion of an apparatus. The exterior member is member configured to be displaceable between a first position where a first edge portion is overlapped with an inner side of another member forming an exterior adjacent to the exterior member and a second position where the first edge portion is not overlapped with the other member. The locking portion is a portion configured to catch on a part of the body portion, thereby restricting displacement of a portion of the exterior member that is proximate to a second edge portion located on a side opposite to the first edge portion in a direction away from the body portion. The elastic member is a member configured to support the exterior member at a position proximate to the second edge portion. The elastic member retains the exterior member at the first position, and is elastically deformed until the exterior member is displaced from the first position to the second position in response to an external force applied to the exterior member.

An image forming apparatus according to another aspect of the present disclosure includes the exterior member mounting structure according to one aspect of the present disclosure.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view of an image forming apparatus including an exterior member mounting structure according to an embodiment of the present disclosure.

FIG. 2 is a first perspective view of an exterior member of the exterior member mounting structure according to the embodiment.

FIG. 3 is a second perspective view of the exterior member of the exterior member mounting structure according to the embodiment.

FIG. 4 is a perspective view of an elastic displacement mechanism of the exterior member mounting structure according to the embodiment.

FIG. 5 is a cross-sectional view of an operating recess of the exterior member mounting structure according to the embodiment.

FIG. 6 is a first cross-sectional view of the exterior member mounting structure according to the embodiment.

FIG. 7 is a second cross-sectional view of the exterior member mounting structure according to the embodiment.

### DETAILED DESCRIPTION

Hereinafter, an embodiment will be described with reference to the accompanying drawings. Note that the following embodiment is an example of embodiments of the present disclosure, and is not intended to limit the technical scope of the present disclosure.

Image Forming Apparatus

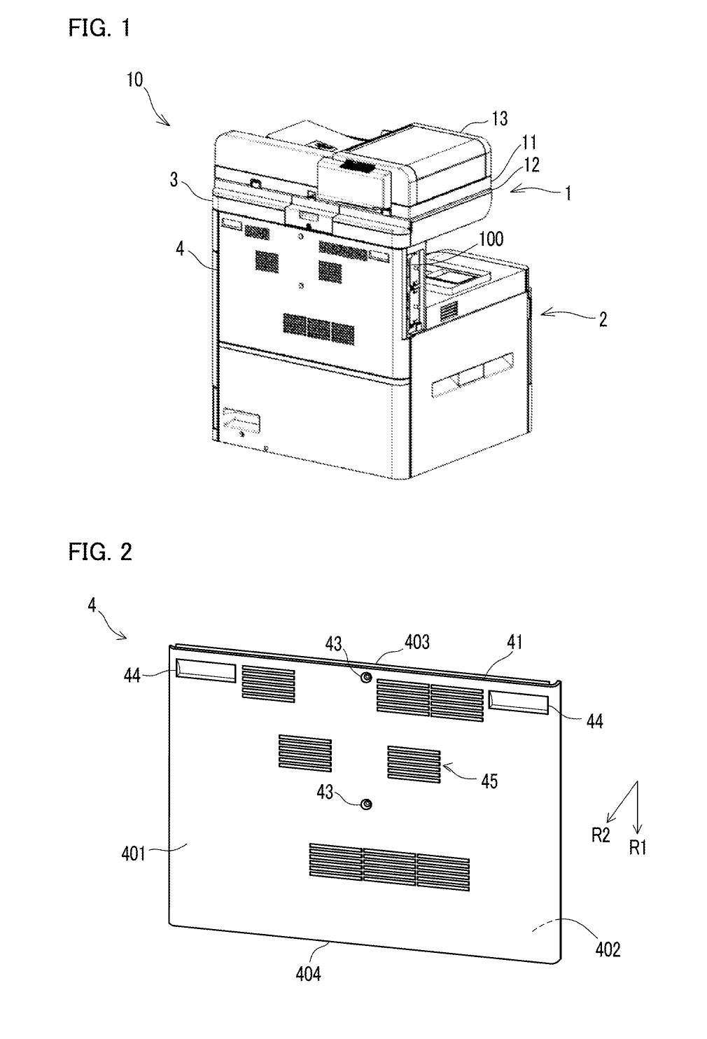

First, a configuration of an image forming apparatus 10 including an exterior member mounting structure according to an embodiment will be described with reference to FIGS. 1 and 2.

The image forming apparatus 10 includes at least an image forming portion 2, and the image forming apparatus 10 illustrated in FIG. 1 further includes an image reading portion 1. The image forming apparatus 10 is a printer, a copier, a facsimile, a multifunction peripheral having a plurality of image processing functions, or the like.

A plurality of exterior members are mounted to a body portion 100 of the image forming apparatus 10. The exterior members include a first exterior member 4, which is to be mounted with the exterior member mounting structure according to the present embodiment, and a second exterior member 3 adjacent thereto.

The first exterior member 4 and the second exterior member 3 are, for example, molded members of a synthetic resin such as polypropylene, polyethylene, polyvinyl chloride, polybutylene terephthalate or polyamide.

The image reading portion 1 includes a document platen 11, an image scanning portion (not shown), a document platen cover 12, and so forth. For example, an Auto Document Feeder (ADF) 13 is incorporated into the document platen cover 12.

The image scanning portion scans a document placed on the document platen 11, emits light toward the document, and converts the reflected light from the document into image data by using an image sensor (not shown).

The image scanning portion also has the function of emitting light toward the document fed by the ADF 13 and converting the reflected light from the document into image data by using the image sensor.

The image forming portion 2 forms, on a recording sheet, an image corresponding to the image data received from an external apparatus or the image data output by the image reading portion 1. The recording sheet is a sheet-like image forming medium such as paper, coated paper, a post card, an envelope or an OHP sheet.

The image forming portion 2 is an electrophotographic image forming portion including a sheet feeding portion, an image carrier, a charging portion, an optical scanning portion, a developing portion, a transfer portion, a fixing portion, and so forth, which are not shown. Note that it is also conceivable that the image forming portion 2 forms an image by using other methods such as an inkjet method.

The charging portion uniformly charges a photosensitive layer on the surface of the image carrier, and the optical scanning portion writes an electrostatic latent image onto the surface of the image carrier. Furthermore, the developing portion supplies developer to the image carrier to develop the electrostatic latent image.

The feeding portion feeds the recording sheet, and the transfer portion transfers the developer image on the surface of the image carrier onto the recording sheet being fed. Furthermore, the fixing portion heats the developer image on the recording sheet to fix the image onto the recording sheet.

In the example illustrated in FIG. 1, the first exterior member 4 and the second exterior member 3 are members forming the rear exterior of the image forming apparatus 10. The second exterior member 3 is mounted to a position above the position in the body portion 100 at which the first exterior member 4 is mounted.

FIG. 2 is a perspective view of the first exterior member 4. FIG. 2 is a perspective view of the first exterior member 4 as seen from its outer surface 401 side. As illustrated in FIG. 2, the first exterior member 4 is a plate-like member formed substantially in a rectangular shape.

In the example illustrated in FIGS. 1 and 2, screw hole portions 43, vents 45, and so forth are formed in the first exterior member 4. Each screw hole portion 43 is a portion in which a hole through which a screw for fixing the first exterior member 4 to the body portion 100 is formed.

In the following description, an edge portion constituting one side of the first exterior member 4 on the second exterior member 3 side and an edge portion located on the opposite side are referred to as a first edge portion 403 and a second edge portion 404, respectively. A direction from the first edge portion 403 side of the first exterior member 4 toward the second edge portion 404 side is referred to as a first direction R1, and a direction from an inner surface 402 side of the first exterior member 4 toward the outer surface 401 side is referred to as a second direction R2.

The screw hole portion 43 is formed at least at a position in the first exterior member 4 that is proximate to the first edge portion 403. In the example illustrated in FIG. 2, two screw hole portions 43 are formed at a position proximate to the first edge portion 403 and a position in the vicinity of the center of the first exterior member 4. The two screw hole portions 43 are each formed at the central position in the first exterior member 4 in a width direction orthogonal to the first direction R1.

The first edge portion 403 is formed at a position proximate to the inner surface 402 relative to the portion located toward the second edge portion 404 side with respect to the first edge portion 403. Accordingly, a height difference 41 is formed between the first edge portion 403 and the portion located toward the second edge portion 404 side with respect to the first edge portion in the first exterior member 4.

As will be described later, the first exterior member 4 is mounted to the body portion 100 in a state where the first edge portion 403, which forms one side of the first exterior member 4, is overlapped with the inner side of the edge portion of the adjacent second exterior member 3. This makes it possible to prevent formation of a gap between the two adjacent exterior members 3 and 4 by using a simple structure.

However, when it is necessary to remove the first exterior member 4 that is internally overlapped, it takes time and effort to first remove the adjacent second exterior member 3 that is externally overlapped.

The exterior member mounting structure of the image forming apparatus 10 enables easy removal of the first exterior member 4 configured to be mounted to the body portion 100 in a state where the first edge portion 403 is overlapped with the inner side of the adjacent second exterior member 3.

Exterior Member Mounting Structure

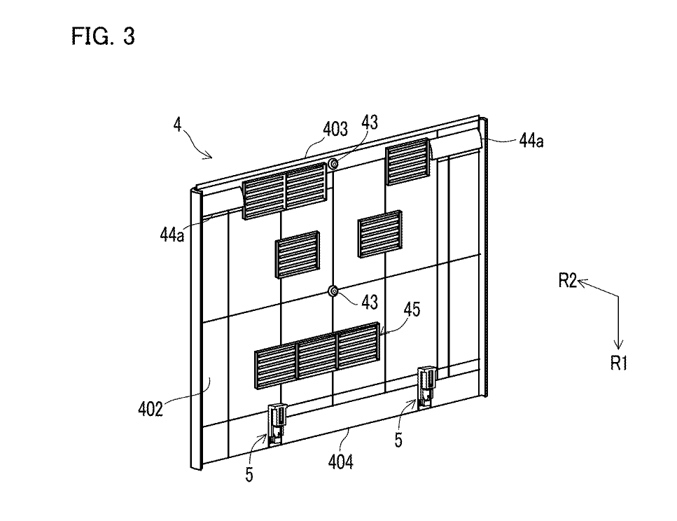

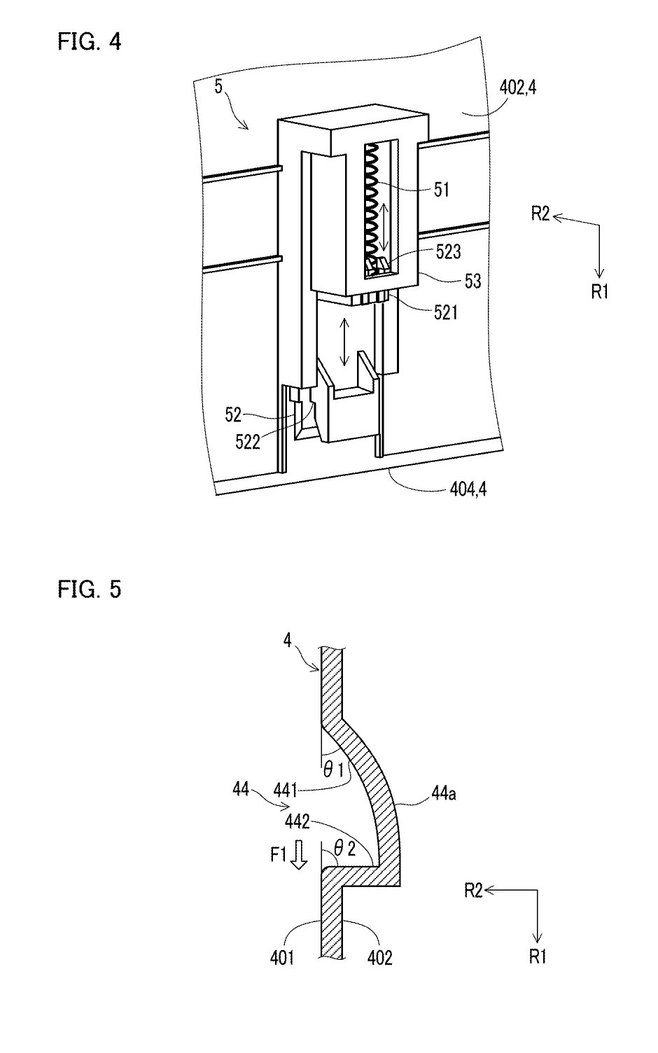

Next, a mounting structure of the first exterior member 4 according to the embodiment will be described with reference to FIGS. 2 to 7. The mounting structure includes the first exterior member 4 and elastic displacement mechanisms 5. Each elastic displacement mechanism 5 includes an elastic member 51, a supporting portion 52, and a guiding portion 53.

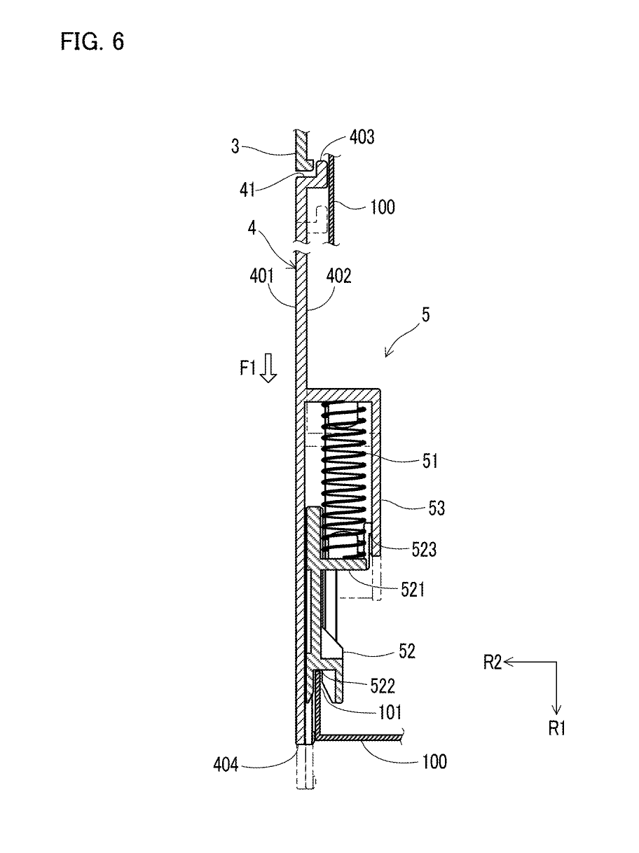

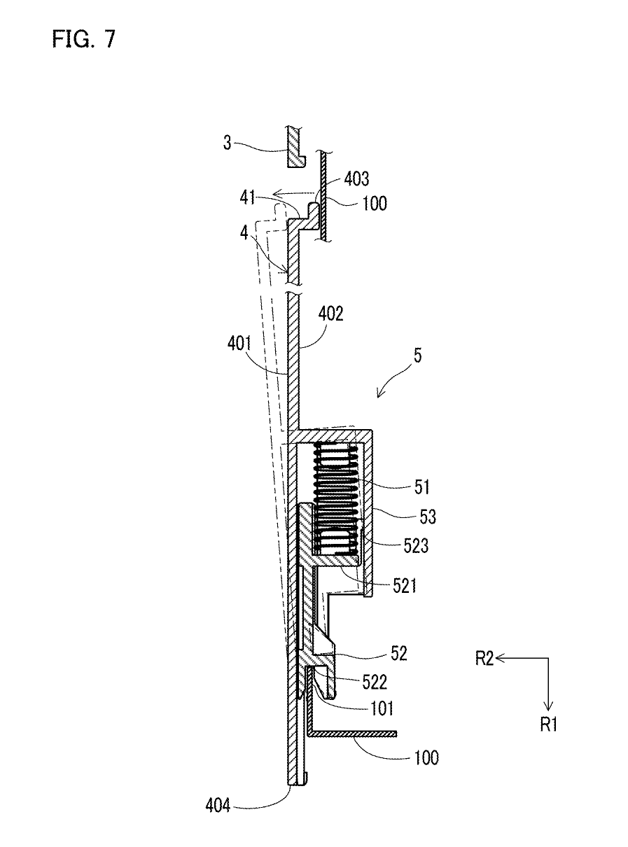

The first exterior member 4 is a member configured to be displaceable between an overlapped position where the first edge portion 403 is overlapped with the inner side of the adjacent second exterior member 3 and a non-overlapped position where the first edge portion 403 is not overlapped with the second exterior member 3. FIG. 6 illustrates a state where the first exterior member 4 is located at the overlapped position, and FIG. 7 illustrates a state where the first exterior member 4 is located at the non-overlapped position.

As illustrated in FIGS. 2 and 5, operating recesses 44 for applying an external force F1 in the first direction R1 are formed on the outer surface 401 of the first exterior member 4. Each operating recess 44 is formed at a position in the first exterior member 4 that is proximate to the first edge portion 403. Two operating recesses 44 are formed at positions proximate to opposite ends of the first exterior member 4 in the width direction orthogonal to the first direction R1. Note that the portion of each operating recess 44 on the inner surface 402 side is a projection 44a since the first exterior member 4 is a plate-like member.

In the following description, a side surface on the first edge portion 403 side within the operating recess 44 is referred to as a first side surface 441, and a side surface on the second edge portion 404 side within the operating recess 44 is referred to as a second side surface 442.

The operating recess 44 is a portion operated when the first exterior member 4 is removed from the body portion 100. More specifically, the operating recess 44 is operated in order to apply the external force F1 in the first direction R1 to the first exterior member 4.

As illustrated in FIG. 5, the angle θ2 that the second side surface 442 forms with a plane in the periphery of the operating recess 44 is approximately 90 degrees. Thus, the external force F1 in the first direction R1 is easily applied to the first exterior member 4 by putting one's hand on the second side surface 442 of the operating recess 44.

The angle θ1 that the first side surface 441 forms with a plane in the periphery of the operating recess 44 is smaller than the angle θ2. Accordingly, the first side surface 441 is an inclined surface that forms an angle smaller than 90 degrees with the peripheral plane.

When the first side surface 441 is an inclined surface, it is difficult to apply an external force in the direction opposite to the first direction R1 to the first exterior member 4 by putting one's hand on the second side surface 442 of the operating recess 44. Accordingly, it is possible to prevent the operating recess 44 from being utilized for any use other than for applying the external force F1 in the first direction R1 to the first exterior member 4. Consequently, it is possible to prevent such inconvenience that the first exterior member 4 is damaged as a result of the operating recess 44 being used for carrying the image forming apparatus 10, for example.

In the present embodiment, the elastic displacement mechanism 5 supports the first exterior member 4 so as to be reciprocally displaceable along the first direction R1. The first exterior member 4 is supported by the elastic displacement mechanism 5 so as to be displaceable between the overlapped position and the non-overlapped position. The length by which the first exterior member 4 is displaceable along the first direction R1 is greater than at least the amount of overlap of the first edge portion 403 with the second exterior member 3.

The elastic displacement mechanism 5 is provided at a position proximate to the second edge portion 404 on the inner surface 402 of the first exterior member 4. Two elastic displacement mechanisms 5 are formed at positions proximate to opposite ends of the first exterior member 4 in the width direction.

In each of the elastic displacement mechanisms 5, the elastic member 51 is an elastically deformable member such as a spring or rubber. The elastic member 51 extends and contracts in the first direction R1 by being elastically deformed. The elastic member 51 in the present embodiment is a coil spring. Note that it is also conceivable that the elastic member 51 is a leaf spring or a synthetic resin member having flexibility.

The elastic member 51 supports the first exterior member 4 at a position proximate to the second edge portion 404. In the present embodiment, the elastic member 51 supports the first exterior member 4 by supporting the guiding portion 53 formed integrally with the first exterior member 4. In other words, the elastic member 51 supports the first exterior member 4 via the guiding portion 53.

The elastic member 51 retains the first exterior member 4 at the overlapped position, and is elastically deformed until the first exterior member 4 is displaced from the overlapped position to the non-overlapped position in response to the external force F1 in the first direction R1 applied to the first exterior member 4.

In the elastic displacement mechanism 5, the supporting portion 52 is interposed between the body portion 100 and the elastic member 51, and supports the elastic member 51 from the second edge portion 404 side in a direction along the first direction R1. In other words, the supporting portion 52 supports the elastic member 51 toward a direction opposite to the direction of the first direction R1.

In the elastic displacement mechanism 5, the guiding portion 53 is formed on the inner surface 402 of the first exterior member 4. In the present embodiment, the guiding portion 53 is a synthetic resin member formed integrally with the first exterior member 4.

The guiding portion 53 is formed in the shape of a frame that contains the elastic member 51, and guides the deformation direction of the elastic member 51 in a direction along the first direction R1. In other words, the guiding portion 53 restricts the bending deformation of the elastic member 51 in a direction intersecting the first direction R1. Consequently, the elastic member 51 is elastically deformed smoothly in the first direction R1.

Furthermore, the guiding portion 53 guides the relative displacement direction of the first exterior member 4 with respect to the supporting portion 52 in a direction along the first direction R1. In other words, the guiding portion 53 restricts displacement of that guiding portion 53 in a direction intersecting the first direction R1 in the positional relationship with the supporting portion 52. This allows the guiding portion 53 and the first exterior member 4 to be slidable with respect to the supporting portion 52 along the first direction R1.

A first end of the elastic member 51 is in contact with the inner surface of the frame-shaped guiding portion 53, and a second end of the elastic member 51 is in contact with the supporting portion 52. Accordingly, the elastic member 51 is elastically deformed in the direction along the first direction R1 in response to displacement of the first exterior member 4 and the guiding portion 53 in the direction along the first direction R1.

In the present embodiment, the elastic member 51 contracts by elastic deformation when the first exterior member 4 is displaced from the overlapped position to the non-overlapped position.

A contact portion 521, a first locking portion 522 and a second locking portion 523 are formed on the supporting portion 52. The contact portion 521 is a portion in contact with the second end of the elastic member 51. The first locking portion 522 is formed at a portion located on the side opposite to the contact portion 521.

The first locking portion 522 is a portion configured to catch on a part of the body portion 100, thereby restricting displacement of the portion of the first exterior member 4 that is proximate to the second edge portion 404 toward the second direction R2. Note that the second direction R2 is a direction away from the body portion 100.

In the example illustrated in FIGS. 6 and 7, the first locking portion 522 is a recess forming an opening on the second edge portion 404 side. In a state where an edge portion 101 of the body portion 100 is fitted into the recess of the first locking portion 522, the first locking portion 522 restricts displacement of the portion of the first exterior member 4 that is proximate to the second edge portion 404 in the second direction R2.

The second locking portion 523 is a portion configured to catch on a part of the guiding portion 53, thereby preventing the supporting portion 52 from being separated from the guiding portion 53. As long as the state where the second locking portion 523 catches on a part of the guiding portion 53 is maintained, the supporting portion 52 prevents the elastic member 51 from falling off from the inner side of the frame-shaped guiding portion 53.

Method of Removing First Exterior Member

Next, a method of removing the first exterior member 4 from the body portion 100 will be described with reference to FIGS. 6 and 7.

First, a screw (not shown) fixed to the body portion 100 through the screw hole portion 43 is removed from the body portion 100. As illustrated in FIG. 6, before and after the removal of the screw, the first exterior member 4 is retained at the overlapped position by the elastic member 51.

Next, the external force F1 in the first direction R1 is applied to the first exterior member 4 by an operator's hand being put on the second side surface 442 of the operating recess 44. Consequently, as illustrated in FIG. 7, the elastic member 51 is elastically deformed along the first direction R1, causing the first exterior member 4 to be displaced from the overlapped position to the non-overlapped position.

The first edge portion 403 of the first exterior member 4 that is present at the non-overlapped position can be displaced in the second direction R2, i.e., a direction away from the body portion 100, without interfering with the second exterior member 3.

When the first exterior member 4 is displaced to the non-overlapped position, the hand put on the second side surface 442 of the operating recess 44 is pulled in the second direction R2. Consequently, the first exterior member 4 pivots about the first locking portion 522 of the supporting portion 52 of the elastic displacement mechanism 5, causing the first edge portion 403 of the first exterior member 4 to move away from the body portion 100.

Finally, the first exterior member 4 is pulled away from the body portion 100 toward the first edge portion 403 side. Consequently, the first locking portion 522 of the elastic displacement mechanism 5 is separated from the edge portion 101 of the body portion 100, thus completing removal of the first exterior member 4.

According to the present embodiment, it is possible to easily remove the first exterior member 4 mounted to the body portion 100 in a state where the first edge portion 403 is overlapped with the inner side of the adjacent second exterior member 3, without removing the second exterior member 3.

In the present embodiment, the guiding portion 53 of the elastic displacement mechanism 5 is formed on the inner surface 402 of the first exterior member 4. This configuration is suitable when a sufficient space for providing the elastic member 51 and the guiding portion 53 that guides the elastic member 51 cannot be easily ensured on the body portion 100 side.

Furthermore, the fact that the guiding portion 53 is a synthetic resin member formed integrally with the first exterior member 4 contributes to the reduction of the number of components and the number of assembly steps.

### APPLICATION EXAMPLES

It is also conceivable that the elastic displacement mechanism 5 is provided in the body portion 100 in the above-described exterior member mounting structure. In this case, the elastic displacement mechanism 5 is provided in an orientation opposite to the orientation illustrated in FIGS. 6, 7 and the like in a direction along the first direction R1. Furthermore, the first locking portion 522 supports a part of the first exterior member 4 from the second edge portion 404 side. In this case, the elastic member 51 supports the first exterior member 4 via the supporting portion 52.

Note that the exterior member mounting structure and the image forming apparatus according to the present disclosure can be configured by freely combining the above-described embodiment and exemplary applications, or by modifying or partly omitting the embodiment and exemplary applications, as needed, within the scope of the disclosure as set forth in the claims.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An exterior member mounting structure comprising:
an exterior member configured to be mounted to a body portion of an apparatus and be displaceable between a first position where a first edge portion is overlapped with an inner side of another member forming an exterior adjacent to the exterior member and a second position where the first edge portion is not overlapped with the other member;
a locking portion configured to catch on a part of the body portion, thereby restricting displacement of a portion of the exterior member that is proximate to a second edge portion located on a side opposite to the first edge portion in a direction away from the body portion; and
an elastic member configured to support the exterior member at a position proximate to the second edge portion, retain the exterior member at the first position, and be elastically deformed until the exterior member is displaced from the first position to the second position in response to an external force applied to the exterior member.

2. The exterior member mounting structure according to claim 1, further comprising a guiding portion configured to guide a deformation direction of the elastic member in a direction along a direction from the first edge portion side of the exterior member toward the second edge portion side.

3. The exterior member mounting structure according to claim 2, wherein the guiding portion is formed on an inner surface of the exterior member.

4. The exterior member mounting structure according to claim 1,
wherein an operating recess for applying the external force is formed on an outer surface of the exterior member, and
a side surface on the first edge portion side within the operating recess is an inclined surface forming a smaller angle with a plane in a periphery of the operating recess than with a side surface on the second edge portion side.

5. An image forming apparatus comprising the exterior member mounting structure according to claim 1.
